(19) United States
(12) Patent Application Publication
(10) Pub. No.: US 2005/0054532 A1
(43) Pub. Date: Mar. 10, 2005

(54) Combination of crop protection agents with hydrogen bond-forming polymers

(76) Inventors: Jean Kocur, Hofheim (DE); Gerhard Frisch, Wehrheim (DE); Jochen Wurtz, Bingen am Rhein (DE); Udo Bickers, Wietmarschen (DE); Erwin Hacker, Hochheim (DE); Hans Philipp Huff, Eppstein (DE); Gerhard Schnabel, Elsenfeld (DE)

Correspondence Address: FROMMER LAWRENCE & HAUG, 745 FIFTH AVENUE- 10TH FL., NEW YORK, NY, 10151, US

(21) Appl. No.: 10/942,235

(22) Filed: Sep. 16, 2004

Related U.S. Application Data
(63) Continuation of application No. 09/853,134, filed on May 9, 2001.

(30) Foreign Application Priority Data
May 11, 2000 (DE) 10022990.5

(51) Int. Cl. A01N 47/36; A01N 25/10

(52) U.S. Cl. 504/211; 504/360

(57) ABSTRACT

The present invention describes the combination of an agrochemically active compound with a polymer with formation of hydrogen bonds for the controlled release of this active compound. Both the polymer and active compound have functional groups which permit the formation of hydrogen bonds.

The present invention relates to combinations of crop protection agents with those oligomeric or polymeric auxiliaries which form hydrogen bonds with suitable functional groups of the active compound and permit a controlled release of an active compound. The combinations can be used to increase crop selectivities and to reduce antagonisms and give particularly good results in the case of herbicides, in particular in the case of mixtures of herbicides with growth regulators and safeners.

It is known that various application problems, reduced activity owing to antagonistic interactions between two or more active compounds and insufficient ‘crop compatibility’ and associated undesirable damage to the plants can occur during the application of various agrochemical products, for example herbicides, fungicides, insecticides, plant growth regulators, safeners or fertilizers. It is furthermore known that these phenomena are frequently observed during ‘foliar application’, and again in particular in the case of herbicides or else of mixtures of herbicides with safeners and/or growth regulators.

To avoid these problems, a ‘split application’, for example, or an overdosage of the active compound that is antagonized has been recommended for cases of reduced activity owing to antagonism. In the case of poor selectivity or insufficient crop compatibility, it is often likewise possible to use split application; an alternative option is underdosage. However, for various reasons, all of these procedures are rather unattractive and uneconomical. When using split application, the active compound formulation has to be applied at least twice; this is time-consuming and labor-intensive. Overdosage of an active compound results in additional expenditure, underdosage involves the risk of reduced yields owing to insufficient control of harmful organisms.

U.S. Pat. No. 5,428,000 discloses active compound compositions comprising a herbicide for broad-leaved weeds and a herbicide for weed grasses. The herbicide for weed grasses has a neutral charge; in contrast, the herbicide for broad-leaved weeds is of anionic nature and is present in combination with a hydrophilic polymer, the polymer being a copolymer formed from an ammonium-containing compound and a compound which does not contain any ammonium. The ammonium-containing compound is generally derived from aromatic and nonaromatic nitrogen heterocycles, ammonium derivatives of acrylic acid and benzylammonium compounds. Thus, the polymers are exclusively polymers in which the quaternary nitrogen atom is not contained in the main chain of the polymer. The hydrophilic polymers used are exclusively copolymers of the abovementioned type. The herbicides for weed grasses used are sethoxydim, alloxidim, fluazifop, quizalofop or fenoxaprop; for broad-leaved weeds, the use of bentazone, imazaquin, acifluorfen, fomesafen, chlorimuron, imazethapyr, thifensulfuron and 2,4D has been described.

DE 198 33 066 disdoses aqueous dispersions of polymers with cationic functionality and redispersible powders obtainable from the dispersions, and also their use, inter alia for the delayed release of active compounds of any kind.

It is an object of the present invention to provide formulations of crop protection agents using which split applications and the requirement of over- or underdosage can be avoided.

This object is achieved by a combination of at least one agrochemically active compound, in particular a herbicide, with a polymer with formation of electrostatic interaction in the form of intermolecular hydrogen bonds between these components for the controlled release of active compound. Polymer and active compound have functional groups which permit the formation of intermolecular hydrogen bonds between polymer and active compound.

It has been found that problems such as poor selectivity and insufficient crop compatibility or reduced activity caused by antagonism can be avoided by combining certain polymers capable of forming hydrogen bonds with one or more agrochemically active compounds.

The present invention furthermore provides the application of the combination according to the invention for controlling undesirable harmful organisms, in particular undesirable grasses and broad-leaved weeds.

In the present invention, the term ‘polymer’ includes both oligomers and polymers, and homo- and copolymers or -oligomers of the corresponding monomers, i.e. molecules having a low degree of polymerization and also those having a high degree of polymerization. The molecular weights MN of the compounds which can be used according to the invention as polymers are at least about 500.

In the polymer/active compound combination according to the invention, some or all of the agrochemically active compound enters into an attractive reversible intermolecular interaction with the polymer. These interactions are electrostatic interactions in the form of intermolecular hydrogen bonds. The agrochemically active compound can be a single active compound having partial selectivity. Alternatively, it is also possible for an active compound which, in an intended type of mixture of two active compounds, shows antagonistic action, to interact with the polymer. It is also possible for two or more active compounds from an active compound mixture to enter into such an interaction.

The polymers used according to the invention can also be surface-active molecules. Owing to their physicochemical properties, they can be dispersed, emulsified or dissolved in water and/or organic solvents. The polymers are preferably dissolved, the preferred solvents being polar protic and polar aprotic organic solvents and water. Most preferably, the polymers dissolve in water.

Polymers suitable for the combinations according to the invention preferably penetrate only slowly, or not at all, into the harmful organism, penetration generally taking place, for example, via the leaf or the root. In general, the absorption or penetration rate of the polymers used according to the invention is between <0.01% and 80%, preferably considerably less than 50%, in 24 hours. The polymers used according to the inventon have those functional groups in the molecule which are capable of forming intermolecular hydrogen bonds with functional groups present in the molecules of the agrochemically active compound and interact with the active compound in such a manner that controlled release of the active compound to the plant to be treated and/or into the soil is possible.

So that hydrogen bonds can be formed between the polymers and the agrochemically active compound, the polymer and the active compound have to have a sufficient number of functional groups which can serve as hydrogen donors and as hydrogen acceptors. Here, the donor and acceptor function can be identical, as in the case of the OH function. However, the chemical nature of the donor and acceptor function may also be different. It is possible within the scope of the present invention that the donor function is located a the polymer or the agrochemically active compound or both. The same applies to the acceptor function.

Examples of functional groups capable of forming hydrogen bonds include the functions
—OH, —NH₂, —NH—, —SO₂NH—, —SO₂NH₂, —CONH—, —CONH₂, —COOH, —CON<, ═N—, —N═N—, 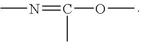
   Other suitable functions are known to the person skilled in the art.

In general, the mean molecular weight MN of the polymers used according to the invention is >500, preferably from about 1 000 to about 1 000 000. These polymers are homo- or copolymers, can in some cases also be present in oligomer form, and are produced in customary polymerization reactions, for example polyadditions, polycondensations, free-radical and ionic polymerizations and metal-complex-catalyzed polymerizations. Also suitable are modified or unmodified natural polymers, for example polypeptides and polysaccharides.

Suitable polymers which have the abovementioned functional groups suitable for forming hydrogen bonds are organic polymers, based, for example, on vinyl, acrylic and allyl monomers, and inorganic polymers, for example alkali metal silicates.

Examples of preferred polymers include polyvinyl alcohol, poly(meth)acrylic acid, poly(meth)acrylamide, polyamides both of the type prepared by condensation of diamines with dicarboxylic acids (nylon) and of the type prepared by addition of lactams (Perlon), polymers of unsaturated dicarboxylic acids, for example of maleic acid, polymers of polyhydric unsaturated alcohols, for example of 1,2-butenediol and 1,4-butenediol, polyvinylpyrrolidones (for example Luviskol® from BASF or PVP-K from ISP), polyvinyl acetates or partially hydrolyzed polyvinyl acetates (for example the products offered by Clariant under the name Mowiol®), lignosulfonates (for example of the Ufoxan®, Borresperse® or Vanisperse® type from Borregard/Norway, or of the Reax® or Kraftsperse® type from Westvac®), polysaccharides and alkyl polysaccharides (for example of the APG series from Cognis), cellulose derivatives, for example hydroxymethylcelluloses (obtainable from Clariant), xanthane derivatives (for example Rhodopol® 23 from Rhodia or Keizan® S from Kelco), polyols, for example polyethylene glycol and polypropylene glycol and block copolymers of polyethylene glycol and polypropylene glycol and also ethers thereof (obtainable from Clariant and also from BASF AG under the name Pluronic®), adducts of ethylene glycol and propylene glycol to polyvalent amines, for example to ethylenediamine (obtainable from BASF under the name Tetronic®), polycarbonates, polyaspartates, polystyrene sulfonates and polystyrene sulfates, polyvinyl sulfates and polyvinyl phosphates. Further polymers having functional groups suitable for forming hydrogen bonds are known to the person skilled in the art. In general, commercial products will be employed.

Agrochemically active compounds suitable for the present invention and having functional groups can be present even before formulation in a form suitable for the combination according to the invention. However, it is also possible that these active compounds are converted into a suitable form only during formulation or preparation of the ‘tank mix’.

Active compounds suitable for use in the combinations according to the invention are preferably the agrochemically active compounds which belong to the group of the herbicides, fungicides, insecticides, growth regulators, safeners, molluscicides, acaricides and nematicides.

Particularly suitable for combination with the hydrogen bond-forming polymers used according to the invention are: herbicides, and among these in particular acetolactate synthase (ALS) inhibitors, such as, for example, sulfonylureas and salts thereof, imidazolinones, such as, for example, imazamox or imazethamethapyr or derivatives thereof, such as salts or esters; bispyribac or salts thereof, chloransulam-methyl or salts thereof; hydroxybenzonitriles, such as, for example, bromoxynil and ioxynil and derivatives thereof, in particular salts, bentazone, ‘aryloxyalkylcarboxylic acids’ and salts and esters thereof, such as MCPA, 2,4-D, CMPP, 2,4-DP, 2,4DB, ‘(hetero)aryloxyaryloxyalkylcarboxylic acids’ and salts and esters thereof, such as, for example, fenoxaprop-ethyl, dichlofop, clodinafop-propargyl, fluazifop add or esters, HPPDO inhibitors, for example mesotrione or sulcotrione, cycdohexanedione oximes, for example sethoxidim, clethodim or trialkoxidim, carbamates, phenylureas, triazines, diquat, paraquat, glufosinate and glyphosate; growth regulators or hormone-like substances, such as, for example, indolylacetic acid or indolylbutync acid or auxins; safeners, such as, for example, mefenpyr-diethyl and 5,5biphenyl-2-isoxazoline-3-carboxylic acid.

Most suitable for combination with the polymers used according to the invention are sulfonylureas of the formula (I) and salts thereof, for example alkali metal salts or ammonium salts, which may or may not contain organic substituents, most preferably Na, K, ammonium, tetraalkylammonium, tetraalkylolammonium or monoalkylammonium salts.
R—SO₂—NH—C(O)—NR′(Het) (I)

In formula (1), R′ is hydrogen or a (C₁-C₁₀)-alkyl radical, preferably hydrogen or methyl,
R is a radical selected from the group consisting of the compounds corresponding to formulae (Ia) to (If) 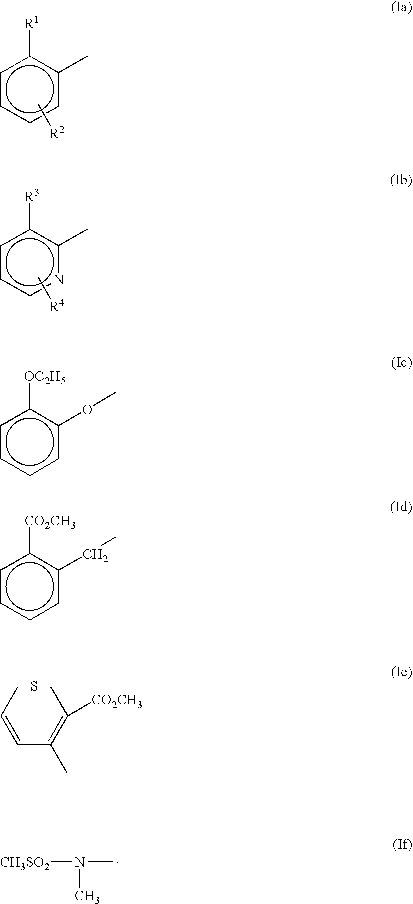
   in which R¹ is selected from the group consisting of
—CO₂(C₁-C₁₀-alkyl), 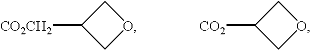
   —CO₂N(C₁-C₁₀-alkyl), SO₂(C₁-C₄-alkyl), CF₃, —O(C₁-C₁₀-alkyl), —OCH₂CH₂Cl, CH₂CH₂CF₃, halogen, preferably Cl or F,
R², R³, R⁴ independently of one another are H, CH₃, —OH, —O(C₁-C₁₀-alkyl), —NH(C₁-C₁₀-alkyl), —N(C₁-C₁₀-alkyl)₂, NHCHO, —NHCO₂(C₁-C₁₀-alkyl), —CH₂NHSO₂CH₃, halogen, preferably F, Cl, Br or I,
Het is a compound of the formula 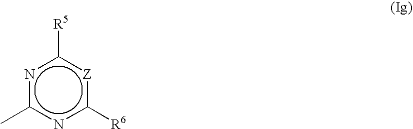
   in which R⁵, R⁶ independently of one another are halogen, preferably F or Cl, —O(C₁-C₄-alkyl), C₁-C₄-alkyl, —NH(C₁-C₄-alkyl), —N(C₁-C₄-alkyl), —OCH₂CF₃, —OCHCl₂, and
Z is N or a CH group.

In the case of all the abovementioned agrochemically active compounds it is, of course, also possible, if appropriate, to use the corresponding derivatives known to the person skilled in the art as being suitable for use, such as acids, esters or salts of the active compounds.

The combinations according to the invention permit the phytotoxic potential of active compounds to be reduced and antagonization of other active compounds in mixtures with the former to be suppressed. Active compounds to be combined according to the invention can therefore be used together with other active compounds or as sole active compound, if appropriate together with customary additives and adjuvants. Examples of preferred combinations according to the invention are described below. In all these combinations, the use of the active compounds described above as being particularly suitable or most suitable is, of course, likewise preferred, even if this is not explicitly mentioned.

The agrochemically active compounds combined with the polymers used according to the invention can be formulated with other active compounds which, if appropriate, can likewise be combined according to the present invention with polymers, to afford mixtures giving advantageous results.

In the combinations according to the invention the weight ratio of polymer to active compound or active compounds is, depending on the molecular weight of the monomer and the active compound and on other physicochemical parameters known to the person skilled in the art, from 0.001:1 to 1:0.001, preferably from 0.01:1 to 1:0.01, in particular from 0.1:1 to 1:0.1.

The agrochemically active compounds combined according to the invention also permit crop compatibility to be enhanced. Thus, in the application of herbicides belonging to the group of the sulfonylureas, in particular herbicides of the formula (I), crop compatibility can be increased significantly by adding polymers such as polyvinyl alcohol or polyvinyl alcohol derivatives, such as, for example, partially acetylated polyvinyl alcohol, generally in a ratio of from 0.01:1 to 1:0.01, preferably from0.1:1 to 1:0.1.

A preferred embodiment of the present invention are combinations in which an agrochemically active compound, For example a herbicide is partially or fully combined according to the invention with a polymer, the combination additionally comprising at least one further agrochemically active compound, for example a herbicide or safener.

In a further preferred embodiment of the present invention, herbicides are formulated with safeners and/or growth regulators in combination with the polymers, where at least one of the agrochemically active compounds has been partially or fully combined according to the invention with these polymers.

A further preferred embodiment of the combinations according to the invention comprises mixtures of one or more graminicides with one or more herbicides which act against broad-leaved weeds, where at least one of the agrochemically active compounds has been combined according to the invention. In a further preferred embodiment, one or more graminicides are mixed with a safener, where at least one of the agrochemically active compounds has been partially or fully combined according to the invention.

It is furthermore preferred to combine one or more herbicides having a rapid mechanism of action with one or more herbicides having a relatively slow mechanism of action, where at least one of the agrochemically active compounds has been partially or fully combined according to the invention.

In many cases, it is advantageous to add adjuvants or adjuvant mixtures, for example oils, specific solvents, surfactants or surfactant mixtures. Here, adjuvants are to be understood as meaning those additives to active compound/polymer combinations which are not active themselves but enhance the properties of the active compound. Suitable adjuvants are nonionic surfactants, for example those of the formula RO(CH₂CH₂O)ₙH, in which R is a (C₁₀-C₂₂)-fatty alcohol radical, a tristyrylphenol radical, a tributylphenol radical, a (C₁-C₁₄)-alkylphenol radical, a tridecyl alcohol radical, a glyceride radical or a radical derived from castor oil and n is an integer of from 1 to 500, preferably from 3 to 200.

Such substances are obtainable, for example, as Genapol®, Sapogenat® and Arkopal® series from Clariant GmbH and as Soprophor series from Rhodia GmbH. It is also possible to employ block copolymers based on ethylene oxide, propylene oxide and/or butylene oxide, for example the compounds sold by BASF AG under the names Pluronics® or Tetronics®.

Anionic or betainic surfactants, too, can be used. Examples of anionic surfactants include calcium dodecylbenzylsulfonate, succinates, phosphated, sulfated and sulfonated nonionic surfactants, for example those of the type mentioned above, and sorbitates, these anionic compounds being neutralized with alkali metal, alkaline earth metal or ammonium ions. Such surfactants are available, for example, under the name Genapol® LRO (Clariant GmbH).

Betainic surfactants are obtainable, for example, from Goldschmidt AG under the name Tegotain®.

Also suitable are cationic surfactants, for example those based on quaternary ammonium, phosphonium and tertiary sulfonium salts, for example Atlas® G3634 A from Uniquema.

The amount of surfactant used is from 10 to 2 000 g/ha, preferably from 50 to 2 000 g/ha. The addition of nitrogen, for example in the form of urea, ammonium nitrate, ammonium sulfate, ammonium hydrogen sulfate or mixtures thereof, is likewise often advantageous.

Formulations comprising combinations according to the invention are described in an exemplary manner below.

It is possible to use suitable polymers, described above, together with ALS (acetolactate synthase) inhibitors, preferably sulfonylureas of the formula (I), to improve crop compatibility, such as in crops of corn, wheat, barley, rice, soybeans, sugar beet or cotton.

It is possible to increase the crop selectivity of iodosulfuron-methyl sodium (1.10 g/ha) by combination with a suitable polyvinyl alcohol or partially hydrolyzed polyvinyl acetate (for example of the Mowiol® type from Clariant GmbH) in a weight ratio of from 0.1:1 to 1:0.1, without any adverse effect on weed control.

Even any antagonistic action of anionic agrochemically active compounds, in particular of herbicides, for example sulfonylureas or salts thereof, hydroxybenzo-nitriles, for example bromoxynil and salts thereof and ioxynil and salts thereof, or aryloxyalkylcarboxylic acids and salts thereof on graminicides, for example fenoxaprop-P-ethyl, can be reduced or avoided by using the polymers. For example, in the active compound combination fenoxaprop-P-ethyl (30-90 g/ha), iodosulfuron-methyl sodium (1-10 g/ha) and mefenpyr-diethyl (10-60 g/ha), any antagonism is considerably reduced by addition of suitable polymers, for example the abovementioned polyvinyl alcohol or polyvinyl alcohol derivatives, such as partially hydrolyzed polyvinyl acetate (for example Mowiol® 4-88), and the action of fenoxaprop-P-ethyl on grasses is improved considerably. Such a combination is particularly suitable for controlling undesirable vegetation in wheat.

Preferred combinations and formulation according to the present invention are mentioned below.

To reduce the phytotoxic potential and to increase the selectivity in crop plants such as wheat, rice and corn, ALS inhibitors, in particular sulfonylureas and salts thereof (for example iodosulfuron, metsulfuron or rimsulfuron) can be formulated with polyvinyl alcohols or partially hydrolyzed polyvinyl acetates. Further substances which may optionally be present are safeners, other herbicides, adjuvants or fertilizers, for example ammonium sulfate, ammonium hydrogen-sulfate, urea or ammonium nitrate.

To prevent any reduced action of graminicides owing to antagonistic interactions, ALS inhibitors, in particular sulfonylureas and salts thereof (for example iodosulfuron, metsulfuron, tribenuron, thifensulfuron, ethoxysulfuron, bensulfuron or rimsulfuron) can be combined with polymers such as polyvinyl alcohols or partially hydrolyzed polyvinyl acetates. These combinations can be mixed with graminicides, for example fenoxaprop-P-ethyl, dicdofop-methyl, clodinafop propargyl or dethodim. Further substances which may optionally be present are safeners, other herbicides, adjuvants or fertilizers, for example ammonium sulfate, ammonium hydrogensulfate, urea or ammonium nitrate.

The percentage of the active compounds in the various formulations can be varied within wide ranges. The formulations comprise, for example, from about 0.01 to 95% by weight of active compounds, about 90-10% by weight of liquid or solid carriers and, if appropriate, up to 50% by weight, preferably 30% by weight, of surfactants, where the sum of these percentages should be 100%.

The mixtures, prepared according to the invention, of polymer, one or more active compounds and the possible adjuvants and other auxiliaries can be present as a separate tank mix, and also in other formulatons.

Suitable possible formulations are, for example:
wettable powders (WP), water-soluble powders (SP), suspension concentrates (SC) based on oil or water, water-soluble concentrates (SL), emulsifiable concentrates (EC), micro- and macroemulsions (EW/ME), such as oil-in-water and water-in-oil emulsions, sprayable solutions, suspension emulsions (SE), oil-miscible solutions, capsule suspensions (CS), dusts (DP), seed-dressing compositions, granules for broadcasting and soil application, granules (GR) in the form of microgranules, spray granules, coating granules and adsorption granules, water-dispersible granules (WDG), water-soluble granules (WSG), ULV formulations, microcapsules and waxes.

These individual formulation types are known in principle and are described, for example, in Winnacker-Küchler, “Chemische Technologie∞ [Chemical Technology], Volume 7, C. Hanser Verlag Munich, 4th Edition, 1986; Wade van Valkenburg, “Pesticide Formulations”, Marcel Dekker, N.Y., 1973; K Martens, “Spray Drying” Handbook, 3^{rd} Ed. 1979, G. Goodwin Ltd. London.

Formulation auxiliaries, such as inert materials, surfactants, solvents and other additives, are likewise known and are described, for example, in Watkins, “Handbook of Insecticide Dust Diluents and Carriers”, 2^{nd} Ed., Darland Books, Caldwell N.J., H.v.Olphen, “Introduction to Clay Colloid Chemistry”, 2^{nd} Ed., J. Wiley & Sons, N.Y.; C. Marsden, “Solvents Guide”, 2^{nd} Ed., Interscience, N.Y. 1963; McCutcheon's “Detergents and Emulsifiers Annual”, MC Publ. Corp., Ridgewood N.J.; Sisley and Wood, “Encyclopedia of Surface Active Agents”, Chem. Publ. Co. Inc., N.Y. 1964; Schönfeldt, “Grenzflächenaktive Äthylenoxidaddukte [Surface-Active Ethylene Oxide Adducts]”, Wiss. Verlagsgesell., Stuttgart 1976; Winnacker-Küchler, “Chemische Technologie”, Volume 7, C. Hanser Verlag Munich, 4th Edition 1986.

Wettable powders are preparations which are uniformly dispersible in water and which contain, in addition to the combination according to the invention and apart from a diluent or inert substance, surfactants of ionic and/or nonionic nature (wetting agents, dispersants), for example polyethoxylated alkylphenols, polyethoxylated fatty alcohols, polyethoxylated fatty amines, fatty alcohol polyglycol ether sulfates, alkanesulfonates, alkylbenzenesulfonates, sodium lignosulfonate, sodium 2,2′-dinaphthylmethane-6,6′-disulfonate, sodium dibutyinaphthalenesulfonate or else sodium oleoylmethyltaurate. To prepare the wettable powders, the active compounds are finely ground in customary apparatus such as hammer mills, fan mills or airlet mills, and are mixed simultaneously or subsequently with the formulation auxiliaries and the polymers used according to the invention.

Emulsifiable concentrates are prepared by dissolving the active compound in combination with the polymer in an organic solvent, for example butanol, cyclohexanone, dimethylformamide, xylene or else relatively highboiling aromatic compounds or hydrocarbons or mixtures of the organic solvents, with the addition of one or more surfactants of ionic and/or nonionic nature (emulsifiers). Examples of emulsifiers which can be used are: calcium alkylarylsulfonates, such as calcium dodecylbenzenesulfonate, or nonionic emulsifiers, such as alkylaryl polyglycol ethers different from para-alkylphenol ethoxylates, fatty acid polyglycol esters, fatty alcohol polyglycol ethers, propylene oxide-ethylene oxide condensation products, alkyl polyethers, sorbitan esters, for example sorbitan fatty acid esters, or polyoxyethylene sorbitan esters, for example polyoxyethylene sorbitan fatty acid esters.

Dusts are obtained by grinding the active compound in combination with polymers to be used according to the invention with finely divided solid substances, for example talc, natural clays, such as kaolin, bentonite and pyrophillite, or diatomaceous earth.

Suspension concentrates can be water- or oil-based. They can be prepared, for example, by wet milling using commercially customary bead mills, with or without the addition of surfactants as already mentioned above under the other formulation types.

Emulsions, for example oil-in-water emulsions (EW), can be prepared, for example, by means of stirrers, colloid mills and/or static mixers using aqueous organic solvents and, if desired, surfactants, for example as already mentioned above under the other formulation types.

Granules can be prepared either by spraying the active compound in combination with the polymer to be used according to the invention onto adsorptive, granulated inert material or by applying the combination to the surface of carriers, such as sand, kaolinites or of granulated inert material, by means of adhesives, for example sugars, such as pentoses and hexoses, or alternatively mineral oils. Suitable active compounds in combination with the polymer to be used according to the invention can also be granulated in the manner which is customary for the preparation of fertilizer granules, if desired as mixtures with fertilizers.

Water-dispersible granules are generally prepared by the customary processes, such as spray-drying, fluidized-bed granulation, disk granulation, mixing using high-speed mixers, and extrusion without solid inert material.

For the preparation of disk, fluidized-bed, extruder and spray granules, see, for example, the processes in “Spray-Drying Handbook” 3^{rd} Ed. 1979, G. Goodwin Ltd., London; J. E. Browning, “Agglomeration”, Chemical and Engineering 1967, pages 147 ff.; “Perry's Chemical Engineer's Handbook”, 5^{th} Ed., McGraw-Hill, New York 1973, pp. 8-57.

For further details on the formulation of crop protection agents, see, for example, G. C. Klingman, “Weed Control as a Science”, John Wiley and Sons, Inc., New York, 1961, pages 81-96 and J. D. Freyer, S. A. Evans, “Weed Control Handbook”, 5^{th} Ed., Blackwell Scientific Publications, Oxford, 1968, pages 1.01-103.

In addition, said formulations of the combinations according to the invention may comprise the tackifiers, wetting agents, dispersants, emulsifiers, penetrants, preservatives, antifreeze agents, solvents, fillers, carriers, colorants, antifoams, evaporation inhibitors and pH and viscosity regulators which are customary in each case.

Based on these formulations, it is also possible to prepare mixtures with other pesticidally active compounds, such as herbicides, insecticides, fungicides, and also antidotes or safeners, fertilizers and/or growth regulators, for example in the form of a finished formulation or for use as tank mixes.

The combinations according to the invention have outstanding activity. If herbicides are combined with polymers to give the combinations according to the invention, the combinations have excellent herbicidal activity against a broad spectrum of economically important monocotyledonous and dicotyledonous harmful plants. The active compound combinations also act efficiently on perennial weeds which produce shoots from seeds or rhizomes, root stocks or other perennial organs and which are difficult to control. In this context, it is immaterial whether the combinations according to the invention are applied pre-sowing, preemergence or post-emergence. The combinations according to the invention are preferably applied to above-ground parts of plants. The combinations according to the invention are also suitable for dessicating crop plants such as potato, cotton and sunflower.

In the case of herbicidally active compounds, the combinations according to the invention can be used, for example, for controlling the following harmful plants: dicotyledonous weeds of the genera Sinapis, Galium, Stellaria, Matricaria, Galinsoga, Chenopodium, Brassica, Urtica, Senecio, Amaranthus, Portulaca, Xanthium, Convolvulus, lpomoea, Polygonum, Sesbania, Cirsium, Carduus, Sonchus, Solanum, Lamium, Veronica, Abutilon, Datura, Viola, Monochoria, Commalina, Sphenoclea, Aeschynomene, Heteranthera, Papaver, Euphorbia and Bidens.

Monocotyledonous weeds of the genera Avena, Alopecurus, Echinochloa, Setaria, Panicum, Digitaria, Poa, Eleusine, Brachiaria, Lolium, Bromus, Cyperus, Elytrigia, Sorphum, Apera and Scirpus.

If the herbicidal compositions which comprise the combinations according to the invention are applied prior to germination, then the weed seedlings are either prevented completely from emerging, or the weeds grow until they have reached the cotyledon stage but then their growth stops, and, eventually, after three to four weeks have elapsed, they die completely.

If the herbicidal compositions which comprise the combinations according to the invention are applied post-emergence to the green parts of the plants, growth also stops drastically a very short time after the treatment and the weed plants remain at the development stage of the point in time of application, or they die after a certain time, more or less rapidly, so that in this manner competition by the weeds, which is harmful to the crop plants, can be prevented at a very early point in time and in a sustained manner by employing the novel combinations according to the invention, as can associated quantitative and qualitative losses in yield.

Although these combinations according to the invention have excellent herbicidal activity against monocotyledonous and dicotyledonous weeds, damage to the crop plant is insignificant, if there is any damage at all.

These effects permit, inter alia, the application rate to be reduced, a broader spectrum of broad-leaved weeds and weed grasses to be controlled, activity gaps to be dosed, also with respect to resistant species, more rapid and safer action, longer duration of action, complete control of the harmful plants using only one or a few applications, and a prolonged application period if a plurality of active compounds are present at the same time.

The abovementioned properties are required for weed control in practice to keep agricultural crops free of undesirable competing plants and thus to safeguard and/or increase the yields qualitatively and quantitatively. With respect to the properties described, the combinations according to the invention are clearly superior to the prior art.

In addition, the combinations according to the invention permit, in an excellent manner, the control of otherwise resistant harmful plants.

Owing to their agrochemical properties, preferably herbicidal, plant-growth-regulatory and safener properties, the combinations used according to the invention can also be employed for controlling harmful plants in crops of known or still to be developed genetically engineered plants. The transgenic plants generally have particularly advantageous properties, for example resistance to certain pesticides, in particular certain herbicides, resistance to plant diseases or causative organisms of plant diseases, such as certain insects or microorganisms such as fungi, bacteria or viruses. Other particular properties relate, for example, to the quantity, quality, storage-stability, composition and to specific ingredients of the harvested product. Thus, transgenic plants having an increased starch content or a modified quality of the starch or those having a different fatty acid composition of the harvested product are known.

The use of the combinations according to the invention in economically important transgenic crops of useful and ornamental plants, for example of cereals, such as wheat, barley, rye, oats, millet, rice, manioc and corn, or else in crops of sugar beet, cotton, soybeans, oilseed rape, potato, tomato, pea and other vegetable species, or in citrus, kiwi and palm tree plantations, is preferred.

The combinations according to the invention can preferably be used in herbicides in crops of useful plants which are resistant or which have been made resistant by genetic engineering toward the phytotoxic effects of the herbicides.

Conventional ways of preparing novel plants which have modified properties compared to known plants comprise, for example, traditional breeding methods and the generation of mutants. Alternatively, novel plants having modified properties can be generated with the aid of genetic engineering methods (see, for example, EP-A-0 221 044, EP-A0 131 624). For example, there have been described in several cases
genetically engineered changes in crop plants in order to modify the starch synthesized in the plants (for example WO 92/11376, WO 92/14827, WO 91/19806),
transgenic crop plants which are resistant to certain herbicides of the glufosinate (cf., for example, EP-A-0 242 236, EP-A-0 242 246) or glyphosate (WO 92/00377) or sulfonylureas (EP-A-0 257 993, U.S. Pat. No. 5,013,659) type,
transgenic crop plants, for example cotton, having the ability to produce Bacillius thuringiensis toxins (Bt toxins) which impart resistance to certain pests to the plants (EP-A0 142 924, EP-A-0 193.259),
transgenic crop plants having a modified fatty acid composition (WO 91/13972).

Numerous molecular biological techniques which allow the preparation of novel transgenic plants having modified properties are known in principle; see, for example, Sambrook et al., Molecular Cloning, A Laboratory Manual, 2nd Ed. Cold Spring Harbor Laboratory Press, Cold Spring Harbor, N.Y., or Winnacker “Gene and Klone”[Genes and Clones], VCH Weinheim 2nd Edition 1996 or Christou, “Trends in Plant Science” 1 (1996)-423-431.

In order to carry out such genetic engineering manipulations, it is possible to introduce nucleic acid molecules into plasmids which allow a mutagenesis or a change in the sequence to occur by recombination of DNA sequences. Using the abovementioned standard procedures, it is possible, for example, to exchange bases, to remove partial sequences or to add natural or synthetic sequences. To link the DNA fragments to one another, it is possible to attach adapters or linkers to the fragments.

Plant cells having a reduced activity of a gene product can be prepared, for example, by expressing at least one appropriate antisense RNA, a sense RNA to achieve a cosuppression effect, or by expressing at least one appropriately constructed ribozyme which specifically cleaves transcripts of the abovementioned gene product.

To this end, it is possible to employ either DNA molecules which comprise the entire coding sequence of a gene product including any flanking sequences that may be present, or DNA molecules which comprise only parts of the coding sequence, it being necessary for these parts to be long enough to cause an antisense effect in the cells. It is also possible to use DNA sequences which have a high degree of homology to the coding sequences of a gene product but which are not entirely identical.

When expressing nucleic acid molecules in plants, the synthesized protein can be located in any desired compartment of the plant cell. However, to achieve locatation in a certain compartment, it is, for example, possible to link the coding region with DNA sequences which ensure locatation in a certain compartment. Such sequences are known to the person skilled in the art (see, for example, Braun et al., EMBO J. 11 (1992), 3219-3227; Wolter et al., Proc. Natl. Acad. Sci. USA 85 (1988), 846850; Sonnewald et al., Plant J.1 (1991), 95-106).

The transgenic plant cells can be regenerated to (give) whole plants using known techniques. The transgenic plants can in principle be plants of any desired plant species, i.e. both monocotyledonous and dicotyledonous plants.

In this manner, it is possible to obtain transgenic plants which have modified properties by overexpression, suppression or inhibition of homologous (=natural) genes or gene sequences or by expression of heterologous (=foreign) genes or gene sequences.

The combinations according to the invention can preferably be used in transgenic crops which are resistant to herbicides from the group of the sulfonylureas, glufosinate-ammonium or glyphosate-isopropylammonium and analogous active compounds.

When using the combinations according to the invention, in particular those in herbiddal compositions, in transgenic crops, in addition to the effects against harmful plants which can be observed in other crops, there are frequently effects which are specific for the application in the respective transgenic crop, for example a modified or specifically broadened spectrum of weeds which can be controlled; modified application rate which can be used for the application; preferably good miscibility or combinability with those herbicides to which the transgenic crop is resistant; and an effect on the growth and the yield of the transgenic crop plants.

The invention is now additionally illustrated in the examples below.

In all examples, seeds or rhizome pieces of mono- and dicotyledonous harmful plants and useful plants were placed in sandy loam soil in pots having a diameter, of 9-13 cm and covered with soil. The pots were kept in a greenhouse under optimum conditions. In the two-leaf to three-leaf stage, i.e. about 3 weeks after start of cultivation, the test plants were treated with the combinations according to the invention in the form of aqueous dispersions or suspensions or emulsions and sprayed onto the green parts of the plant at various dosages, using a water application rate of 300 I/ha (converted). For further cultivation of the plants, the pots were kept in a greenhouse under optimum conditions. Visual scoring of the damage to useful plants and harmful plants was carried out 2-3 weeks after the treatment.

### EXAMPLE 1

Iodosulfuron-methyl sodium salt (5 g/ha) in combination with Mowiol 4-88 (10 g/ha) was applied to crops of wheat and rice. Compared to the use of iodosulfuron-methyl sodium salt (5 g/ha), an increased selectivity and reduced phytotoxicity were observed, with comparable herbicidal action.

### EXAMPLE 2

Iodosulfuron--methyl sodium salt (5 g/ha) was combined with Mowiol® 4-88 (10 g/ha) and applied with Genapol9 LRO (70%, 300 ml/ha) to crops of wheat and rice. Compared to the use of iodosulfuron-methyl sodium salt (5 g/ha) as a mixture with Genapol® LRO (70%, 300 ml/ha), an improved selectivity and reduced phytotoxicity were observed, with comparable herbicidal action.

### EXAMPLE 3

Hussar® OF (1 l/ha) was combined with Mowiol® 4-88 (10 g/ha) and applied to crops of wheat and rice. Compared to the use of Hussar® OF (mixture of 8 g/ha of iodosulfuron-methyl sodium salt, 64 g/ha of fenoxaprop-P-ethyl and 24 g/ha of mefenpyr-diethyl, from Aventis CropScience GmbH), an increased activity, greatly reduced phytotoxicity and better selectivity under stress were observed.

### EXAMPLE 4

Hussar® OF in an amount of 1 l/ha was combined with Mowiol® 4-88 (10 g/ha) and applied as a mixture with Genapol® LRO (70%, 300 ml/ha) to crops of wheat and rice. Compared to the use of Hussar® OF in an amount of 1 l/ha as a mixture with Genapol® LRO (70%, 300 mlvha), an increased activity under stress and greatly reduced phytotoxicity were observed.

### EXAMPLE 5

Application of fenoxaprop-P-ethyl (60 g/ha in the form of Ricestar®) and ethoxysulfuron (49 g/ha in the form of a WG 60) together with Mowiol® 4-88 (40 g/ha) resulted in improved control of broad-leaved weeds and weed grasses compared to the use of fenoxaprop-P-ethyl (60 g/ha in the form of Ricestar®) and ethoxysulfuron (40 g/ha in the form of a WE 60), in particular in stress situations caused by environmental factors.

1. A combination of an agrochemically active compound with a polymer with formation of electrostatic interaction in the form of intermolecular hydrogen bonds for the controlled release of this active compound, wherein the polymer and the active compound have functional groups which permit hydrogen bonds between active compound and polymer being formed.

2. The combination as claimed in claim 1, wherein the active compound is selected from the group consisting of herbicides, fungicides, insecticides, growth regulators, safeners, molluscicides, acaricides and nematicides, in particular from the group consisting of herbicides, growth regulators and safeners.

3. The combination as claimed in claim 2, wherein the herbicides are selected from the group consisting of ALS inhibitors, such as, for example, sulfonylureas, hydroxybenzonitriles, preferably bromoxynil and ioxynil, aryloxyalkylcarboxylic acids, preferably MCPA, 2,4-D, CMPP, 2,4-DP, 2,4-DB, and salts thereof, (hetero)aryloxyaryloxyalkylcarboxylic adds, preferably fenoxaprop-ethyl, dichlofop, clodinafop-propargyl, fluazifop, and derivatives thereof in the form of acids and esters, HPPDO inhibitors, preferably mesotrione or sulcotrione, cyclohexanedione oximes, preferably sethoxidim, clethodim or trialkoxidim, carbamates, phenylureas, triazines, diquat, paraquat, glufosinate and glyphosate, the growth regulators are selected from the group consisting of indolylacetic acid, indolylbutyric acid and auxins, and the safeners are selected from the group consisting of mefenpyr-diethyl and 5,5-biphenyl-2-isoxazoline-3-carboxylic acid, and their respective derivatives, such as acids, esters and salts.

4. The combination as claimed in claim 3, which comprises sulfonylureas of the formula (I) or salts thereof
R—SO₂—NH—C(O)—NR′(Het) (I)
in which R′ is hydrogen or a (C₁-C₁₀)-alkyl radical, preferably hydrogen or methyl,
R is a radical selected from the group consisting of the compounds corresponding to formulae (Ia) to (If) 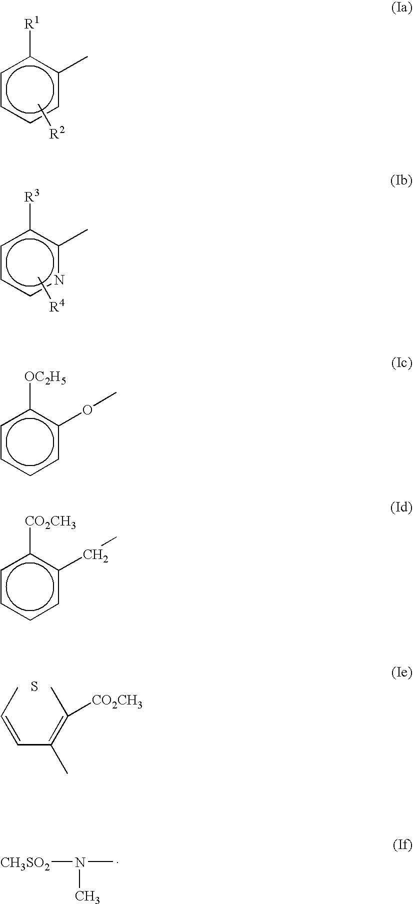
in which R¹ is selected from the group consisting of
—CO₂(C₁-C₁₀-alkyl), 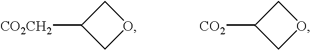
—CO₂N(C₁-C₁₀-alkyl), SO₂(C₁-C₄-alkyl), CF₃, —O(C₁-C₁₀-alkyl), —OCH₂CH₂Cl, CH₂CH₂CF₃, halogen, preferably Cl or F,
R², R³, R⁴, independently of one another are H, CH₃, —OH, —O(C₁-C₁₀-alkyl), —NH(C₁-C₁₀-alkyl), —N(C₁-C₁₀-alkyl)₂, NHCHO, —NHCO₂(C₁-C₂-alkyl), —CH₂NHSO₂CH₃, halogen, preferably F, Cl, Br or I,
Het is a compound of the formula 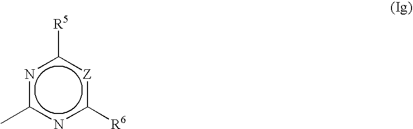
in which R⁵, R⁶ independently of one another are halogen, preferably F or Cl, —O(C₁-C₄-alkyl), C₁-C₄-alkyl, —NH(C₁-C₄-alkyl), —N(C₁-C₁₀-alkyl)₂, —OCH₂CF₃, —OCHCl₂, and
Z is N or a CH group.

5. The combination as claimed in claim 1, wherein the polymer is soluble, dispersible or emulsifiable in water and/or organic solvents, preferably soluble in polar protic and/or polar aprotic organic solvents and/or water, preferably soluble in water, and has an absorption rate or penetration rate of <50% in 24 h.

6. The combination as claimed in claim 1, wherein the molecular weight of the polymer is about >500, preferably about 1 000 to 1 000 000, and the polymer is employed in a weight ratio to the active compound of from about 0.001:1 to about 1:0.001, preferably from 0.01:1 to 1:0.01, most preferably from 0.1:1 to 1:0.1.

7. The combination as claimed in claim 1, wherein the functional groups in the polymer which are suitable for forming hydrogen bonds and the active compound are selected independently of one another from the group consisting of
—OH, —NH₂, —NH—, —SO₂NH—, —SO₂NH₂, —CONH—, —CONH₂, —COOH, 'CON<, ═N—, —N═N—,

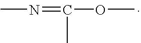

8. The combination as claimed in claim 1, wherein the polymer is selected from the group consisting of polymers based on vinyl, acrylic and allyl monomers and alkali metal silicates, preferably from the group consisting of polyvinyl alcohol, poly(meth)acrylic acid, poly(meth)acrylamide, polyamides both of the type prepared by condensation of diamines with dicarboxylic acids and of the type prepared by the addition of lactams, polymers of unsaturated dicarboxylic acids, preferably of maleic acid, polymers of polyhydric unsaturated alcohols, preferably of 1,2-butenediol and 1,4-butenediol, polyvinylpyrrolidones, polyvinyl acetates and partially hydrolyzed polyvinyl acetates, polysaccharides and alkyl polysaccharides, preferably hydroxymethylcelluloses, xanthane derivatives, polyols, preferably polyethylene glycol and polypropylene glycol and block copolymers of polyethylene glycol and polypropylene glycol and their ethers, adducts of ethylene glycol and propylene glycol to polyvalent amines, preferably to ethylenediamine, polycarbonates, polyaspartates, polystyrene sulfonates and polystyrene sulfates, polyvinyl sulfates and polyvinyl phosphates.

9. A formulation, comprising a combination as claimed in claim 1 and at least one further component from the group consisting of further agrochemically active compounds, surfactants, fertilizers and customary adjuvants.

10. The formulation as claimed in claim 9, wherein a combination of a herbicide, a safener and/or a growth regulator with a polymer is present.

11. The use of a combination as claimed in claim 1 or of a formulation as claimed in claim 9 or 10 for suppressing antagonistic interactions during the application of agrochemically active compounds for controlling harmful plants.

12. The use of a combination as claimed in claim 1 or of a formulation as claimed in claim 9 or 10 for increasing crop selectivity during the application of one or more agrochemically active compounds for controlling harmful plants.

13. A method for controlling harmful organisms, in particular harmful plants, which comprises applying a combination as claimed in claim 1 or a formulation as claimed in claim 9 or 10.

14. A process for preparing a combination as claimed in claim 1 or a formulation as claimed in claim 9 or 10, which comprises combining the active compound by customary processes which are known per se, preferably by dissolving, stirring or mixing, with a suitable polymer, and introducing this combination into the formulation, if appropriate with other active compounds, adjuvants and additives.
